(19) United States
(12) Patent Application Publication
(10) Pub. No.: US 2024/0300784 A1
(43) Pub. Date: Sep. 12, 2024

(54) MOUNTING SYSTEM FOR ATTACHING A SUPPORT TO A CRANE AND RELATED METHODS

(71) Applicant: LINK-BELT CRANES, L.P., LLLP, Lexington, KY (US)

(72) Inventors: John P. Jones, Nicholasville, KY (US); Kazunori Yamamoto, Obu-shi (JP); Kakuichi Furukawa, Obu-shi (JP)

(21) Appl. No.: 18/601,227

(22) Filed: Mar. 11, 2024

Related U.S. Application Data
(60) Provisional application No. 63/451,332, filed on Mar. 10, 2023.

(51) Int. Cl. B66C 23/74

(52) U.S. Cl. CPC B66C 23/74

(57) ABSTRACT

A crane includes a mounting system for connecting a support, such as a platform for supporting an object, such as an auxiliary power unit. The crane includes an upper structure rotatably supported by a chassis. The mounting system includes a pair of first or upper mounts connected to the upper structure and adapted for connecting to the support. The mounting system further includes a pair of second or lower mounts connected to the upper structure, such as by way of attachment to a counterweight, and adapted for connecting to the support. Related methods are also disclosed.

This application claims the benefit of U.S. Provisional Patent Application Ser. No. 63/451,332, the disclosure of which is incorporated herein by reference.

### TECHNICAL FIELD

This disclosure relates generally to providing an integrated mount on a crane for attaching a support, such as a platform, for one or more objects in need of support in relation to the crane, such as auxiliary power units or other devices.

### BACKGROUND

Lifting machines and, in particular, cranes, typically include a rotatable upper or “super” structure to facilitate moving loads about using an associated boom. The crane may also include a counterweight that serves to balance the load being lifted. An example is shown in commonly owned U.S. Pat. No. 11,097,927, the disclosure of which is incorporated herein by reference.

The crane may utilize an auxiliary power unit mounted onto skids, but such a unit must be moved using a separate helper crane when the primary work crane travels on the jobsite. As an alternative, crane operators sometimes request the ability to attach a frame for supporting an auxiliary power unit onto the crane for performing specialty work operations. Examples of such specialty work includes pile driving, auger cast and other foundation-type work that uses hydraulic power to drive an attachment connected to the crane. Mounting this power unit to the crane itself enables it to move about the jobsite and perform the desired tasks more efficiently.

In the past, crane owners or operators would sometimes design their own mounting features or lugs for connecting a frame. These features may be provided at a suboptimal location on the crane that result in increased loads and wear, and in a manner that is unsecure. Moreover, governmental regulations (e.g., OSHA 1926.1434) provide guidelines for equipment modification relative to cranes used in construction. Avoiding the need for ad hoc mounting arrangements facilitates compliance with such regulations, and provides a degree of certainty to the operator, as well as to the manufacturer.

Accordingly, a need is identified for a mounting system for a crane that avoids the foregoing limitations. The mounting system should be simple and inexpensive to implement and use, and contribute to an overall increase in efficiency in terms of operation of a lifting machine, especially in terms of attaching a support structure to the crane.

### SUMMARY

According to one aspect of the disclosure, a crane including a mounting system for connecting a support is provided. The crane includes an upper structure rotatably supported by a chassis. One or more first mounts are connected to the upper structure and adapted for connecting to the support. One or more second mounts are connected to the upper structure and adapted for connecting to the support.

In one embodiment, the one or more first mounts comprise upper mounting brackets adapted to be removably attached from the upper structure. Each upper mounting bracket comprises a pair of spaced plates adapted for receiving at least three fasteners. The one or more second mounts comprise lower mounting bracket, each including at least one fastener. In one version of the mounting system, a first upper mount and a first lower mount are aligned in a first common vertical plane. A second upper mount and a second lower mount are aligned in a second common vertical plane.

The support may comprise a platform having a pair of arms and a pair of legs. The arms may be on an upper portion of the platform, and the legs may be on a lower portion of the platform. In such case, the first or upper mounts are adapted to connect to one of the pair of upper arms. Likewise, the second or lower mounts are adapted to connect to one of the pair of lower legs.

The crane may further include a counterweight. At least one of the second or lower mounts may be integrally formed with the counterweight. In one example, the counterweight comprises one or more plates, and the second or lower mount(s) are integrally formed with one or more of the plates. In one particular example, the counterweight comprises a stack of two or more plates, and the second or lower mount(s) are integrally formed with a lowermost plate in the stack of plates.

A further aspect of the disclosure relates to a crane including a mounting system for connecting a support. The crane comprises an upper structure rotatably supported by a chassis, the upper structure including a counterweight. One or more first or upper mounts are connected to the upper structure and adapted for connecting to the support. One or more second or lower mounts connected to the counterweight are adapted for connecting to the support.

In one embodiment, the upper mount(s) comprise upper mounting brackets adapted to be removably attached from the upper structure. Each upper mounting bracket comprises a pair of spaced plates adapted for receiving at least three fasteners. The lower mount(s) may comprise lower mounting brackets, each including at least one fastener. A first upper mount and a first lower mount may be aligned in a first common vertical plane, and a second upper mount and a second lower mount may be aligned in a second common vertical plane.

The support comprises a platform having a pair of arms and a pair of legs. The upper mount(s) are each adapted to connect to one of the pair of arms and the lower mount(s) are each adapted to connect to one of the pair of legs.

In one embodiment, the counterweight comprises one or more plates. The lower mounts may be integrally formed with one or more of the plates. The counterweight may further comprise a stack of two or more plates, and the lower mount(s) may be integrally formed with a lowermost plate in the stack of plates.

Still a further aspect of the disclosure relates to a method of connecting a support for supporting an object to a crane including a counterweight. The method comprises attaching the support to one or more upper mounts removably attached to a rotatable upper structure of the crane and to one or more lower mounts associated with the counterweight. In one version, the support comprises a platform, and the method further includes the step of placing an auxiliary power unit on the platform. The method may further comprise connecting the platform to lower mounts associated with a base plate of the counterweight.

### BRIEF DESCRIPTION OF THE DRAWING FIGURES

FIG. 1 is a partially cutaway, partially exploded rear perspective view of a crane including one embodiment of the disclosed mounting system;

FIG. 2 is a partially cutaway rear perspective view of a crane including one embodiment of the disclosed mounting system in an assembled condition;

FIG. 3 is a partially cutaway rear perspective view of a crane including a support in the form of a platform connected to the crane by the disclosed mounting system;

FIG. 4 is a side schematic view of the crane including the platform attached by the mounting system and supporting an object in the form of an auxiliary power unit; and

FIG. 5 is a rear underside view showing the manner in which the lower mounts of the mounting system attach to a counterweight tray.

### DETAILED DESCRIPTION

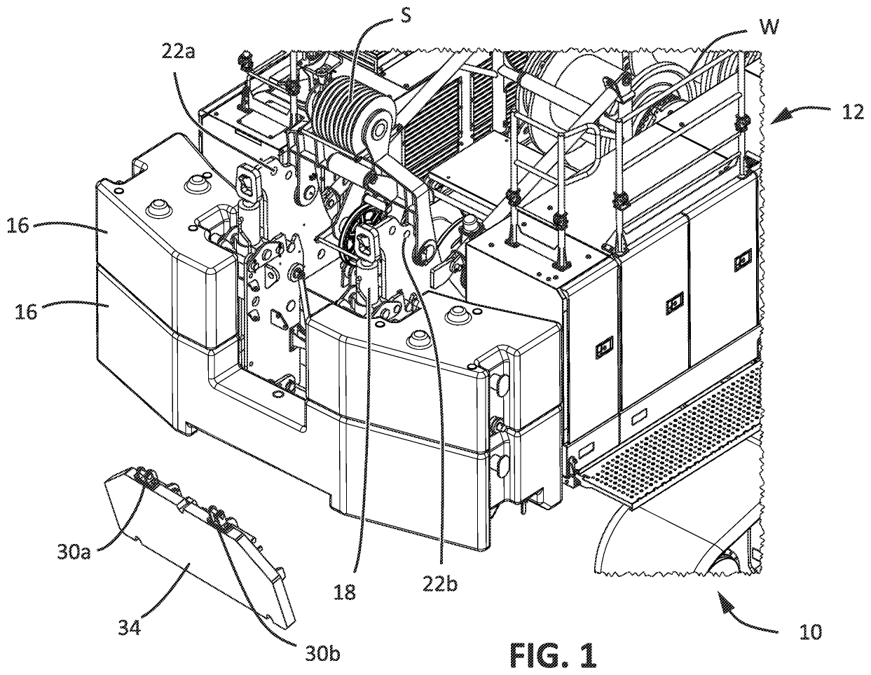

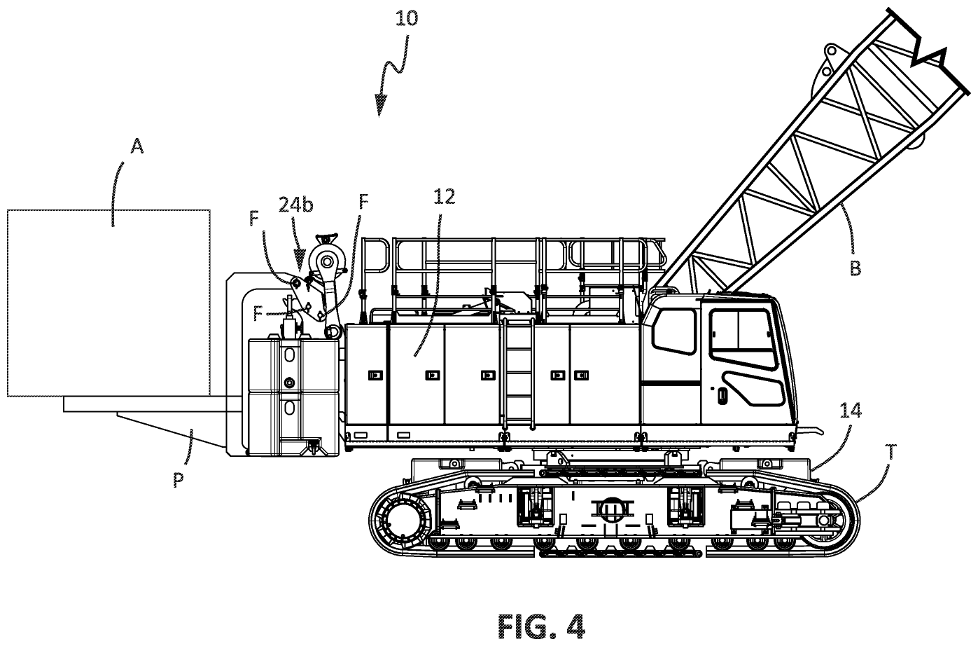

Reference is now made to FIG. 1, which discloses a crane 10 to which aspects of this disclosure may have applicability. As illustrated, the crane 10 includes a rotatable upper or “super” structure 12. The upper structure 12 may be movably mounted to a lower structure, such as a chassis 14, as can be further understood from FIG. 4.

The chassis 14 may include ground-engaging motive devices, such as crawler tracks T or wheels, depending on the application. In any case, the motive devices provide the crane 10 with mobility for moving to and fro about a job site or other location. Outriggers (not shown) may also be provided to lend stability when the crane 10 is immobilized for lifting loads.

The upper structure 12 may include a boom B (see FIG. 4), which may be of the lattice or telescoping variety. One or more sheaves S may be provided on the upper structure 12 for receiving a hoisting rope (not shown). The hoisting rope may be used in connection with the boom and a winch W to raise and lower loads. The rear end portion of the superstructure 12 may include a counterweight for balancing the load. This counterweight may comprise one or more plates 16. A typical arrangement includes at least two plates 16 arranged in a stacked configuration, as shown (and the lowermost plate may be considered a tray for supporting one or more plates). A lifter 18 may be adapted to raise and lower the counterweight relative to the ground depending on the mode of crane operation.

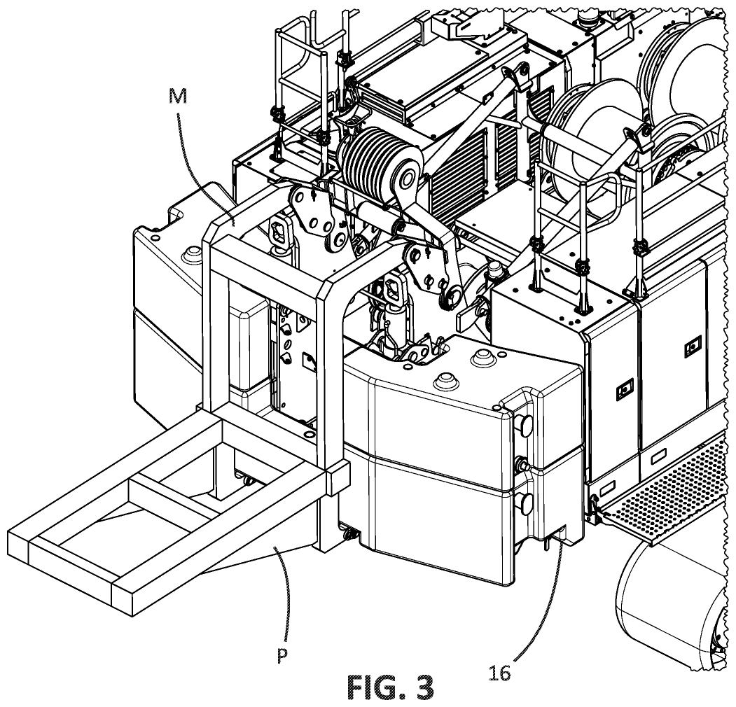

According to one aspect of this disclosure, the crane 10 is provided with a mounting system 20 for attaching a support. The support may comprise, as one example, as a platform P for supporting one or more objects, as shown in FIG. 3. One example of the object in need of support is a power supply, such as an auxiliary power unit A (see FIG. 4).

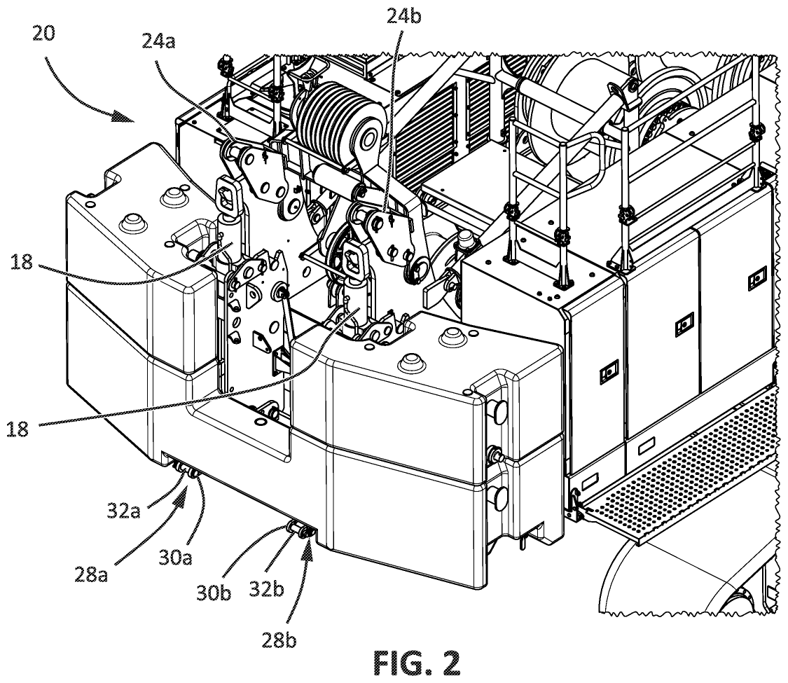

In the illustrated exemplary embodiment, the mounting system 20 comprises one or more primary mounts. In the illustrated example, the primary mounts include a pair of first mounts 22a, 22b, which are arranged to connect with an upper portion of the support. The upper mounts 22a, 22b may each comprise a generally upstanding structure integrally connected to a frame of the upper structure 12. Corresponding brackets 24a, 24b formed by spaced plates, as shown in FIG. 2, are adapted for receiving or engaging the upper mounts 22a, 22b.

In the illustrated version, each upper mount 22a, 22b includes aligned openings for receiving a pair of fasteners F passed through the brackets 24a, 24b to form a secure connection. The brackets 24a, 24b may further include connectors connecting with the support structure (see platform P in FIG. 3), a portion which may be sandwiched between the plates forming the brackets. The connectors used to form the connection between the brackets 24a, 24b and the support structure (that is, the portion sandwiched between the plates) may also be in the form of removable fasteners F (see, e.g., FIG. 4).

As a consequence of this arrangement, the brackets 24a, 24b are removable from the upper mounts 22a, 22b. This removability may be useful in terms of complying with height restrictions in terms of transporting the crane 10. As can be appreciated, the brackets 24a, 24b may be arranged so as to extend above the upper mounts 22a, 22b and rearwardly of the point of connection established by the pair of fasteners F. This serves to distance the corresponding upper portion of the platform P from the upper end of the counterweight plates 16 and the lifter 18.

The mounting system 20 may further include one or more secondary mounts for engaging a different portion of the support. In the illustrated example, these mounts comprise a pair of second mounts 28a, 28b for engaging a lower portion of the support. The lower mounts 28a, 28b may comprise brackets 30a, 30b. Connectors 32a, 32b may also be provided for forming a secure connection with the support structure, such as platform P.

In one particularly desirable embodiment, and as illustrated, the second or lower mounts 28a, 28b are integrated into the counterweight for balancing the loading on the crane 10 resulting from the boom B and loads carried by it. More specifically, the lower mounts 28a, 28b are integrated into the base plate 16 forming part of the counterweight. However, the attachment could be to other plates or portions of a counterweight, without limitation.

In one particular embodiment, as shown in FIG. 1, the brackets 30a, 30b forming the lower mounts 28a, 28b may be integrated into a single component. This single component may be, for example, a plate 34. This plate 34 may then be attached directly to the counterweight base plate 16. However, the integrated mounting points could be provided elsewhere on the crane upper structure 12.

In use, the platform P may be moved into an operative position for attachment to the rear of the crane superstructure 12, as shown. This may result in upper arm members M connected to the platform P having an opening positioned between the plates forming each upper bracket 24a, 24b. One or more fasteners F may then be passed through the upper brackets 24a, 24b to form a secure, but releasable, connection.

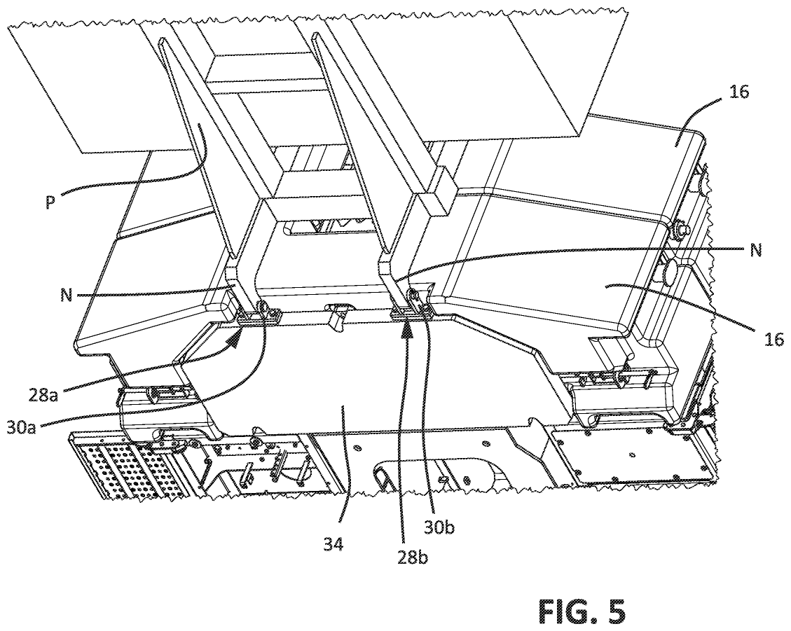

The lower leg members N of the platform P may be similarly associated with the lower brackets 30a, 30b. As perhaps best understood from FIG. 5, the platform P shown is adapted to engage a rear face of one or more of the plates 16. While optional, this may serve to lend a measure of support and stability to the arrangement.

As can be appreciated, in the illustrated example, a first upper mount 22a and a first lower mount 28a may be aligned in a first common vertical plane. A second upper mount 22b and a second lower mount 22b may be aligned in a second common vertical plane. However, this is considered optional, and may depend on the nature of the support (which in the illustrated version is a platform with generally parallel arm members M and generally parallel leg members N aligned in common vertical planes).

The foregoing description of certain embodiments provides an illustration of the principles of the invention and its practical application to thereby enable one of ordinary skill in the art to utilize the invention in various embodiments and with various modifications as are suited to the particular use contemplated. For example, while a mobile crane with a lattice boom is shown in the figures, it can be appreciated that the disclosed aspects may be applied to any type of lifting vehicle that may benefit from the various aspects of this disclosure. All such modifications and variations are within the scope of the invention as determined by the appended claims when interpreted in accordance with the breadth to which they are fairly, legally and equitably entitled.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or the context clearly dictates otherwise. For example, the phrases: “a unit”, “a device”, “an assembly”, “a mechanism”, “a component”, “an element”, and “a step or procedure”, as used herein, may also refer to, and encompass, a plurality of units, a plurality of devices, a plurality of assemblies, a plurality of mechanisms, a plurality of components, a plurality of elements, and, a plurality of steps or procedures, respectively.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated components), feature(s), characteristic(s), parameter(s), integer(s), or step(s), and does not preclude addition of one or more additional component(s), feature(s), characteristic(s), parameter(s), integer(s), step(s), or groups thereof. Each of these terms is considered equivalent in meaning to the phrase “consisting essentially of.” Each of the phrases “consisting of” and “consists of,” as used herein, means “including and limited to”. The phrase “consisting essentially of” means that the stated entity or item (system, system unit, system sub-unit device, assembly, sub-assembly, mechanism, structure, component element or, peripheral equipment utility, accessory, or material, method or process, step or procedure, sub-step or sub-procedure), which is an entirety or part of an exemplary embodiment of the disclosed invention, or/and which is used for implementing an exemplary embodiment of the disclosed invention, may include at least one additional feature or characteristic” being a system unit system sub-unit device, assembly, sub-assembly, mechanism, structure, component or element or, peripheral equipment utility, accessory, or material, step or procedure, sub-step or sub-procedure), but only if each such additional feature or characteristic” does not materially alter the basic novel and inventive characteristics or special technical features, of the claimed item.

Terms of approximation, such as the terms about, substantially, approximately, generally, etc., as used herein, refer to ±10% of the stated numerical value or as close as possible to a stated condition.

It is to be fully understood that certain aspects, characteristics, and features, of the invention, which are, for clarity, illustratively described and presented in the context or format of a plurality of separate embodiments, may also be illustratively described and presented in any suitable combination or sub-combination in the context or format of a single embodiment. Conversely, various aspects, characteristics, and features, of the invention which are illustratively described and presented in combination or sub-combination in the context or format of a single embodiment may also be illustratively described and presented in the context or format of a plurality of separate embodiments.

Although the invention has been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

1. A crane including a mounting system for connecting a support, comprising:
an upper structure rotatably supported by a chassis;
one or more first mounts connected to the upper structure and adapted for connecting to the support; and
one or more second mounts connected to the upper structure and adapted for connecting to the support.

2. The crane of claim 1, wherein the one or more first mounts comprise a pair of upper mounting brackets adapted to be removably attached from the upper structure.

3. The crane of claim 2, wherein each upper mounting bracket of the pair of upper mounting brackets comprises a pair of spaced plates adapted for receiving at least three fasteners.

4. The crane of claim 1, wherein the one or more second mounts comprise a lower mounting bracket including at least one fastener.

5. The crane of claim 1, wherein the one or more first mounts and the one or more second mounts comprise:
a first upper mount and a first lower mount are aligned in a first common vertical plane; and
a second upper mount and a second lower mount are aligned in a second common vertical plane.

6. The crane of claim 1, wherein the support comprises a platform having a pair of arms and a pair of legs, the one or more first mounts comprising a pair of upper mounts, each being adapted to connect to one of the pair of arms, and the one or more second mounts comprising a pair of lower mounts, each being adapted to connect to one of the pair of legs.

7. The crane of claim 1, further including a counterweight, wherein the one or more lower mounts are integrally formed with the counterweight.

8. The crane of claim 7, wherein the counterweight comprises one or more plates, and the one or more lower mounts are integrally formed with one or more of the plates.

9. The crane of claim 7, wherein the counterweight comprises a stack of two or more plates, and the one or more lower mounts are integrally formed with a lowermost plate in the stack of plates.

10. A crane including a mounting system for connecting a support, comprising:
an upper structure rotatably supported by a chassis, the upper structure including a counterweight;
one or more first mounts connected to the upper structure and adapted for connecting to the support; and
one or more second mounts connected to the counterweight and adapted for connecting to the support.

11. The crane of claim 10, wherein the one or more first mounts comprise a pair of upper mounting brackets adapted to be removably attached from the upper structure.

12. The crane of claim 11, wherein each upper mounting bracket comprises a pair of spaced plates adapted for receiving at least three fasteners.

13. The crane of claim 10, wherein the one or more second mounts comprise a pair of lower mounting brackets, each including at least one fastener.

14. The crane of claim 10, wherein the one or more first mounts and the one or more second mounts comprise:
a first upper mount and a first lower mount are aligned in a first common vertical plane; and
a second upper mount and a second lower mount are aligned in a second common vertical plane.

15. The crane of claim 10, wherein the support comprises a platform having a pair of arms and a pair of legs, the one or more first mounts comprise a pair of upper mounts, each being adapted to connect to one of the pair of arms, and the one or more second mounts comprise a pair of lower mounts, each being adapted to connect to one of the pair of legs.

16. The crane of claim 10, wherein the counterweight comprises one or more plates, and the one or more second mounts are integrally formed with one or more of the plates.

17. The crane of claim 10, wherein the counterweight comprises a stack of two or more plates, and the one or more lower mounts are integrally formed with a lowermost plate in the stack of plates.

18. A method of connecting a support for supporting an object to a crane including a counterweight, comprising:
attaching the support to one or more first mounts removably attached to a rotatable upper structure of the crane and one or more second mounts associated with the counterweight.

19. The method of claim 18, wherein the support comprises a platform, and further including the step of placing an auxiliary power unit on the platform.

20. The method of claim 18, further comprising connecting the platform to the one or more second mounts associated with a base plate of the counterweight.
